(19) United States
(12) Patent Application Publication
(10) Pub. No.: US 2003/0094760 A1
(43) Pub. Date: May 22, 2003

(54) Game machine

(76) Inventors: Satoshi Motegi, Ebina-Shi (JP); Masatoshi Satoh, Ebina-Shi (JP); Nobuyasu Tamura, Yokohama-Shi (JP); Kosaku Noda, Yamato-Shi (JP); Misao Yamanaka, Yokohama-Shi (JP); Masanori Suganuma, Yokohama-Shi (JP); Hayato Mizue, Ebina-Shi (JP)

Correspondence Address: Gerald T. Shekleton, Esq., Welsh & Katz, Ltd., 120 S. Riverside Plaza, 22nd Floor, Chicago, IL, 60606, US

(21) Appl. No.: 10/125,848

(22) Filed: Apr. 19, 2002

(30) Foreign Application Priority Data
Nov. 19, 2001 (JP) 353512/2001

(51) Int. Cl. A63F 1/00; G07F 17/34

(52) U.S. Cl. 273/292; 463/20

(57) ABSTRACT

An object of the present invention is to provide a game machine which is capable of successfully combining a game having the realism of a mechanical reel and a display having colorful and rich expressions, which can be set up in an narrow area, and which yields high profitability.

The game machine according to the present invention is a game machine wherein an image display unit is disposed at a position facing the player side, a mechanical reel is disposed on a line intersecting the line connecting the image display unit and the player side, and an illuminance-adjustable illumination unit is provided for illuminating the mechanical reel; and wherein, by providing a half mirror inclined toward the image display unit side or the player side in front of the image display unit and within the plane including the area where the lines intersect, the image of the image display unit that has transmitted through the half mirror and the virtual image of the design drawn on the peripheral face of the mechanical reel that has been reflected by the half mirror are displayed on the same face to the player.

### BACKGROUND OF THE INVENTION

1. Field of the Invention

The present invention generally relates to a game machine, and more particularly to a game machine for displaying the design on a mechanical reel peripheral face and the image of an image display unit.

2. Description of the Related Art

Conventionally, as a game machine employing an image display device using a virtual image, there is a target-hammering game device disclosed in the specification of Japanese Patent Application Laid-Open No. 8-323037.

This target-hammering game machine displays the target image projected on the CRT (Cathode-ray Tube) screen to a player by synthesizing the virtual image of the hammering table and the mirror image of the hammer held by the player by the effect of a half mirror.

During a game, a player plays the game while viewing the screen of the image display device, and swings the hammer down such that the hammer, which is a mirror image, hits the target image.

When the player hammers the target image successfully, a shock sensor detects this hammering motion and outputs a signal, and, based on such signal, the image control device switches the target image on the CRT screen to a successful hit effect image.

In addition, there are a synthesized image display device, game device and bowling game device disclosed in the specification of Japanese Patent Application Laid-Open No. 11-114221.

This synthesized image display device synthesizes an actual ball and an image ball and displays this to an observer, and comprises a CRT display for displaying images, and a mirror for forming a reflective virtual image of such image.

During a game, the actual ball bowled by a player rolls on the traveling face, passes by the mirror, and moves further to the back of the mirror.

Then, when the actual ball passes by the half mirror portion of the mirror, an image ball having the same outer appearance as the actual ball appears, and the actual ball is replaced by this image ball.

In other words, after the actual ball has been hidden behind the mirror, the image ball as a reflective virtual image continues the movement.

In addition, the game device disclosed in the specification of Japanese Patent Application Laid-Open No. 11-104311 structures a variable display device with a rotational drum having a special design on the peripheral face thereof; a drum lamp capable of applying light to the special design of the rotational drum; a half mirror which transmits the special design in a visible manner by virtue of the illumination from the drum lamp; and a projection display mechanism capable of projecting and displaying the projected image on the half mirror, and the projection display mechanism projects and displays a character design as the projected image on the half mirror.

According to the foregoing structure, there is provided a mechanically variable display device capable of displaying a character design in addition to the display of a special design, and the ornamental visual effect is thereby improved.

As described above, the target-hammering game machine disclosed in Japanese Patent Application Laid-Open No. 8-323037 executes a game with the mirror image of the hammer and the background picture thereof by employing a half mirror, which is merely a replacement with image representation of actual items of a whack-a-mole game machine, which is found here and there. Thus, the image displayed to the player is a simple image without novelty.

With the synthesized image display device, game device and bowling game device disclosed in the specification of Japanese Patent Application Laid-Open No. 11-114221, when the actual ball bowled by the player is hidden behind the backside of the mirror, an image ball as the reflective virtual image continues the movement. Although this yields an advantage in that the occupancy space of the game device can be reduced and the device itself can be simplified by disposing the portion of the real item and the portion of the reflective virtual image separately in space, the real item in the game machine is merely replaced with an image representation, and, similarly to the foregoing image display device, the game provided by such game device has no novelty, is simple, and does not improve the amusement of the game.

With the game device disclosed in the specification of Japanese Patent Application Laid-Open No. 11-104311, since the player visually recognizes the special design of the rotational drum through the half mirror, the rotational drum is disposed facing the player, which requires the depth of the game device to contain the volume of the rotational drum, and there is a problem in that the volume of the game device in the depth direction will increase, thereby enlarging the set-up space of the game device.

Further, although the projected image is projected and displayed on the half mirror to overlap the special design of the rotational drum, there is a problem that the display to the player is mainly structured of the special design of the rotational drum, and therefore lacks in display variation and amusement.

### SUMMARY OF THE INVENTION

In view of the foregoing, an object of the present invention is to provide a game machine which is capable of successfully combining a game having the realism of a mechanical reel and a display having colorful and rich expressions, which can be set up in a narrow area, and which yields high profitability.

The game machine according to the first aspect of the present invention is a game machine wherein an image display unit is disposed at a position facing a player side, a mechanical reel is disposed on a line intersecting a line connecting the image display unit and the player side, and an illuminance-adjustable illumination unit is provided for illuminating the mechanical reel; and

wherein, by providing a half mirror, that is inclined toward the image display unit side or the player side, in front of the image display unit and within a plane including an area where the lines intersect, an image from the image display unit that has transmitted through the half mirror and a virtual image of a design drawn on a peripheral face of the mechanical reel that is reflected by the half mirror are displayed on a same face to a player.

According to the foregoing structure, the player will recognize the virtual image as though an actual mechanical reel, and will thereby be able to enjoy a game having the realism similar to an actual mechanical reel.

Moreover, since the mechanical reel is disposed on a line intersecting against the line connecting the image display and the player side, the set-up area can be reduced since the depth measurement of the game machine can be reduced, and the improvement in profitability of the game machine can thereby be sought.

Further, since an illuminance-adjustable illumination unit for illuminating the mechanical reel is provided, the design on the peripheral face of the mechanical reel can be displayed as a virtual image by being reflected on the half mirror in various forms of clearness by suitably adjusting the illuminance, and the representation of the virtual image of the design on the game screen becomes possible by adjusting the illuminance of the illumination unit.

In addition, a widely diverse game structure is possible since a display mode employing a virtual image of the design of the peripheral face of the mechanical reel and an image displayed with an image display unit, and a display mode employing only the image displayed with the image display unit are realized.

The game machine according to the second aspect of the present invention is the game machine of the first aspect described above, wherein the image display unit comprises a flat panel display.

According to the foregoing structure, the depth measurement of the image display unit can be reduced, thereby realizing the reduction in the depth measurement of the game machine. Further profitability of the game machine can thereby be sought.

The game machine according to the third aspect of the present invention is the game machine of the second aspect described above, wherein the flat panel display is a display panel selected from among a liquid crystal display panel, a plasma display panel, an electro-luminescent display panel, and an organic electro-luminescent display panel.

According to the foregoing structure, the flat panel display can be selected and employed among the various types of flat panel displays described above in accordance with the circumstances.

Therefore, according to the present invention, realized is an entertaining game machine capable of successfully combining a game having the realism of a mechanical reel and a display having diverse and rich expressions, the set-up area thereof being narrow and small, and which yields high profitability.

### BRIEF DESCRIPTION OF THE DRAWINGS

FIG. 1 is a perspective view showing the appearance of the slot game machine, which is an embodiment of the game machine according to the present invention;

FIG. 2 is a longitudinal cross section from the side of the principal portion of the slot game machine illustrated in FIG. 1;

FIG. 3 is a diagram conceptually showing the structure of the principal portion of the slot game machine illustrated in FIG. 1;

FIG. 4 is a conceptual diagram showing the display during the game of the slot game machine illustrated in FIG. 1;

FIG. 5 is a diagram showing the structure of the control unit of the slot game machine illustrated in FIG. 1;

FIG. 6 is a conceptual diagram showing, in the slot game machine illustrated in FIG. 1, the structure of a game display in which an image is displayed with a liquid crystal display panel at the upper half area in the game display, and a virtual image of the design of the mechanical reel is displayed at the lower half area in the game display;

FIG. 7 is a conceptual diagram showing, in the slot game machine illustrated in FIG. 1, the structure of a game display in which an image is displayed with a liquid crystal display panel at the upper half area in the game display, and an image of the design of the mechanical reel is displayed with a liquid crystal display panel at the lower half area in the game display; and

FIG. 8 is a diagram showing the half mirror being disposed downward in the slot game machine and the mechanical reel being disposed below such half mirror.

### DESCRIPTION OF THE PREFERRED EMBODIMENTS

The present invention is now described in detail with reference to the drawings representing the embodiments.

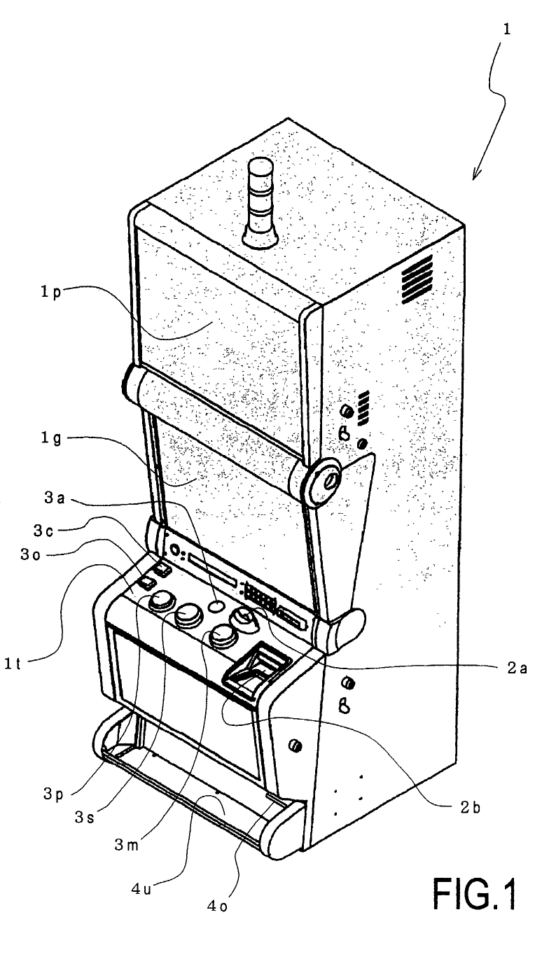

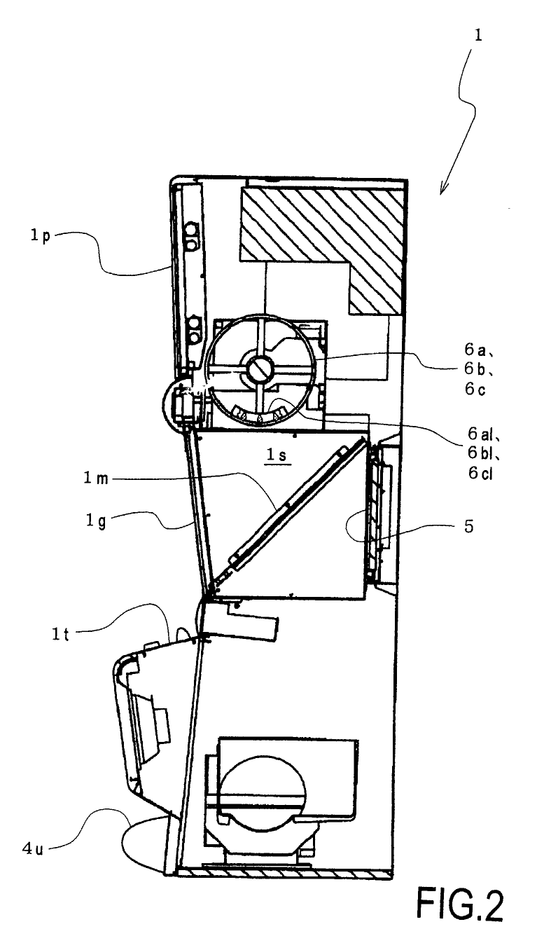

FIG. 1 is a perspective view of the appearance of the slot game machine (game machine) 1 employing the present invention. FIG. 2 is a longitudinal cross section from the side of such slot game machine 1.

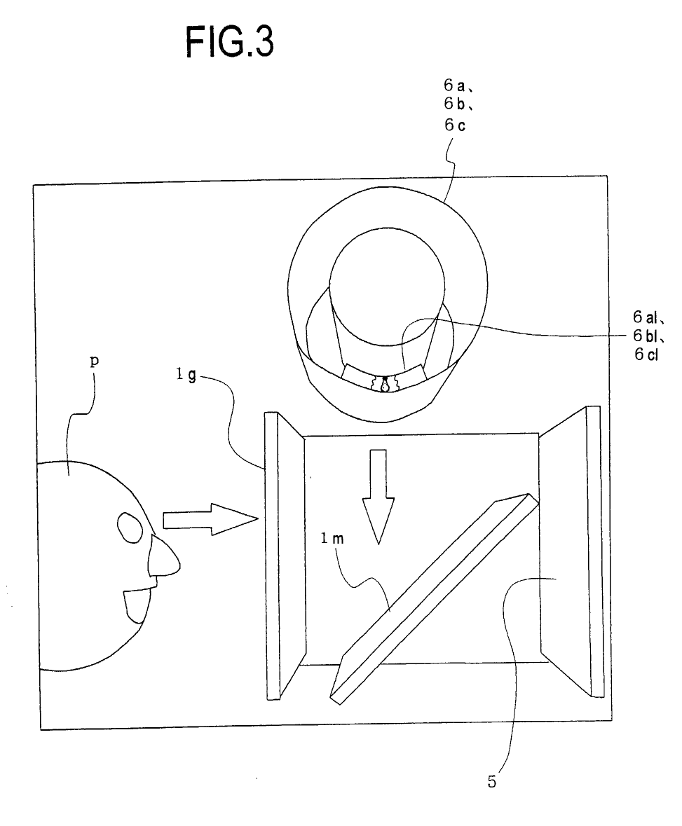

In the slot game machine 1, as shown in FIG. 1, FIG. 2 and FIG. 3, a liquid crystal display panel (image display unit) 5 is provided at a position facing the player in a protective glass 1g through which the player p sees, a half mirror 1m is provided in front of the crystal display panel 5 in a lowered and inclined manner, and one set of mechanical reels 6a, 6b, 6c is disposed within the top box 1p above the half mirror 1m.

In other words, the mechanical reels 6a, 6b, 6c are formed in one set and disposed on the line intersecting against the line connecting the liquid crystal display panel 5 and the player p side, and the half mirror 1m is provided in front of the liquid crystal panel 5 and within the plane including the intersecting area of the line in a lowered and inclined manner toward the player side.

And, an illumination-adjustable reel lamp I (illumination unit) (6al), reel lamp II (illumination unit) (6bl) and reel lamp III (illumination unit) (6cl) for illuminating the designs 6an, 6bn, 6cn drawn respectively on the peripheral face of the mechanical reels 6a, 6b, 6c are disposed within the mechanical reels 6a, 6b, 6c.

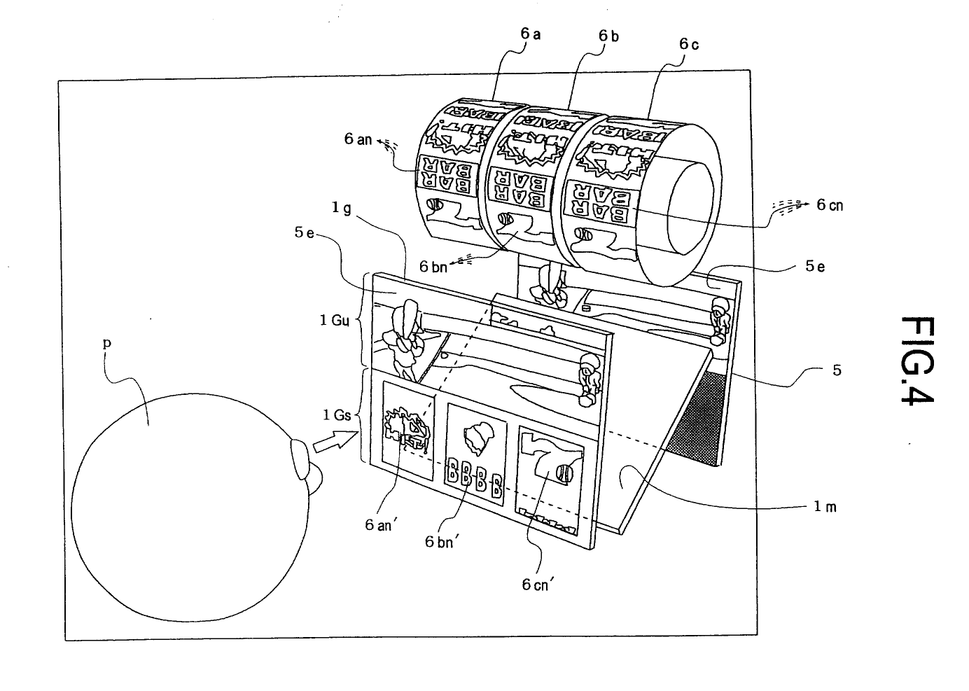

The player p playing the slot game machine 1, as shown in FIG. 4, which is a conceptual diagram during the game, visually recognizes through the half mirror 1m the image 5e displayed on the upper area of the liquid crystal display panel 5 on the upper half area 1Gu of the game display through the protective glass 1g, and visually recognizes the virtual image 6an′ of the design 6an of the peripheral face of the mechanical reel 6a, the virtual image 6bn′ of the design 6bn of the peripheral face of the mechanical reel 6b, and the virtual image 6cn′ of the design 6cn of the peripheral face of the mechanical reel 6c reflected on the half mirror 1m on the lower half area 1Gs of the game display.

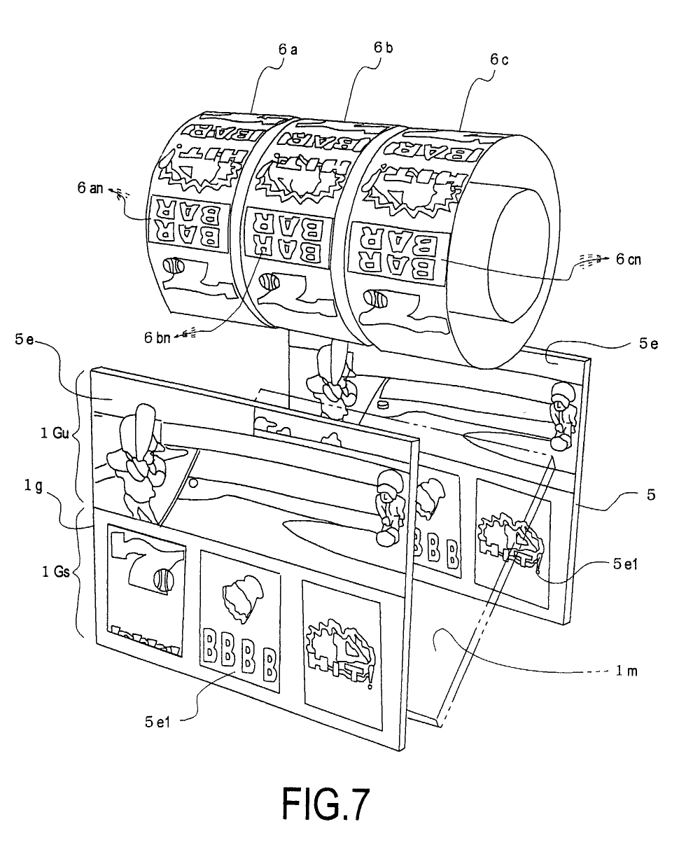

Further, illumination from the reel lamps 6al, 6bl, 6cl to the designs 6an, 6bn, 6cn of the respective peripheral faces of the mechanical reels 6a, 6b, 6c is turned off in order to eliminate the virtual images 6an′, 6bn′, 6cn′ of the designs 6an, 6bn, 6cn, and, as shown in FIG. 7, images 5e, 5el are displayed across the entire area of the liquid crystal display panel 5 in order to display an image across the entire area of the game display within the protective glass 1g.

As shown in FIG. 1 and FIG. 2, provided to the front face of the aforementioned slot game machine 1 is an operational table 1t which is protrusively provided in an anteriorly inclined manner at a position where the player p can manually operate the same with ease. Moreover, a transparent protective glass 1g is provided above the operational table 1t so as to enable the player p to see the game space 1s within the slot game machine 1 as well as to protect the same.

Further, as shown in FIG. 2, a top box 1p housing the mechanical reels 6a, 6b, 6c is formed above the slot game machine 1.

As shown in FIG. 2 and FIG. 3, a liquid crystal display panel 5, which is a flat panel display, is provided in the game space 1s protected with the protective glass 1g at a position facing the player, and a half mirror 1m is disposed at a declining and inclining angle of 45° toward the player side.

Moreover, although the inclination angle of the half mirror lm is set to 45°, it goes without saying that the inclination angle may be set to an angle other than 45° so as long as the designs 6an, 6bn, 6cn of the peripheral face of the mechanical reels 6a, 6b, 6c are reflected on the half mirror 1m, and the player p is able to visually recognize each virtual image 6an′, virtual image 6bn′ and virtual image 6cn′.

Further, although a liquid crystal display panel 5 is used as the image display device for displaying the game image in the present embodiment, needless to say, other image display devices, such as a plasma display panel, electro-luminescent display panel, and organic electro-luminescent display panel and so on may be used in place of the liquid crystal display panel 5.

Moreover, as shown in FIG. 2, the mechanical reels 6a, 6b, 6c are housed in the top box 1p and disposed above the half mirror 1m, and, as shown in FIG. 4, the player p visually recognizes the virtual images 6an′, . . . , 6bn′, . . . , 6cn′, . . . , in which the design 6an, design 6bn and design 6cn on the peripheral face of the mechanical reels 6a, 6b, 6c are reflected on the half mirror 1m, at the lower half area 1Gs of the game display within the protective glass 1g.

The aforementioned mechanical reels 6a, 6b, 6c are formed having a contour of a drum shape in which light materials such as synthetic resin, acryl for example, are selected for the purpose of reducing the weight and inertial force thereof, and, a design sheet having has its material polycarbonate or the like to which the design 6an, . . . is to be drawn is attached to the peripheral face of the mechanical reel 6a, a design sheet having has its material polycarbonate or the like to which the design 6bn, . . . is to be drawn is attached to the peripheral face of the mechanical reel 6b, and a design sheet having has its material polycarbonate or the like to which the design 6cn, . . . is to be drawn is attached to the peripheral face of the mechanical reel 6c.

The aforementioned design 6an, . . . , design 6bn, . . . and design 6cn, . . . are classified, for example, as a design with a specific hand such as the number 7, or other general designs.

The mechanical reels 6a, 6b, 6c structured as described above are each axially supported rotatably around the concentric axis extending horizontally in the left and right directions of the slot game machine 1, and they respectively have favorable consistency with digital control systems, and are rotatably driven independently in a direct drive with a stepping motor (not shown) which rotates in a prescribed angle.

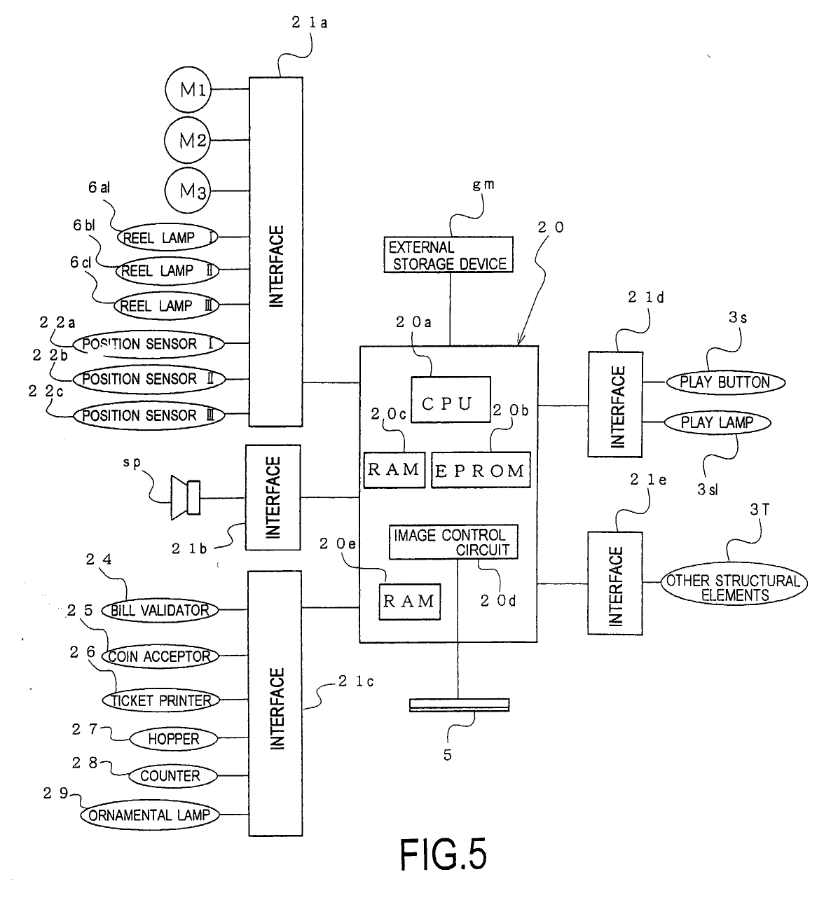

And, in order to make each of the mechanical reels 6a, 6b, 6c stop at a prescribed position determined with internal drawing, a position sensor I (22a), position sensor II (22b) and position III (22c) (c.f. FIG. 5) are respectively applied for each mechanical reel 6a, 6b, 6c for performing position control.

Moreover, light sensors such as photodiodes and phototransistors, or magnetic sensors employing an electromagnetic effect such as electromagnetic induction are suitably selected and used as the position sensors 22a, 22b, 22c.

Further, needless to say, the rotational drive of the mechanical reels 6a, 6b, 6c may suitably adopt a transmission mechanism employing a transmission belt or a gear mechanism.

And, as shown in FIG. 2 and FIG. 3, a reel lamp I (6al), reel lamp II (6bl) and reel lamp III (6cl) for illuminating and conspicuously displaying the designs 6an, . . . , 6bn, . . . , 6cn, . . . on the peripheral face of the mechanical reels 6a, 6b, 6c are disposed respectively within the mechanical reels 6a, 6b, 6c.

Here, illumination of the reel lamp I (6al), reel lamp II (6bl) and reel lamp III (6cl) can be adjusted pursuant to the increase or decrease of the current, and, by suitably adjusting the illuminance thereof, the designs 6an, . . . , 6bn, . . . , 6cn, . . . on the peripheral face of the mechanical reels 6a, 6b, 6c can be displayed in various clearness as the virtual images 6an′, . . . , 6bn′, . . . , 6cn′, . . . by being reflected on the half mirror 1m.

For example, sharp and clear virtual images 6an′, . . . , 6bn′, . . . , 6cn′, . . . can be displayed by increasing the illuminance of the reel lamp 6al, 6bl, 6cl, and obscure and unclear virtual images 6an′, . . . , 6bn′, . . . , 6cn′, . . . can be displayed by decreasing the illuminance.

Thereby realized is the representation of the virtual images 6an′, . . . , 6bn′, . . . , 6cn′, . . . of the designs 6an, . . . , 6bn, . . . , 6cn, . . . on the game display pursuant the adjustment of illumination of the reel lamps 6al, 6bl, 6cl.

Moreover, although the reel lamps 6al, 6bl, 6cl are respectively and internally disposed in the mechanical reels 6a, 6b, 6c in the present embodiment, they may be provided outside the mechanical reels 6a, 6b, 6c.

As shown in FIG. 1, a coin slot 2a for inserting a coin for the player to bet on the slot game and a bill slot 2b for inserting the bill for the player p to bet on the slot game are provided on the operational table 1t.

Further provided on the operational table it are a unit bet button 3p for betting a single unit each time a unit betting amount; for example, 5 cents, 25 cents, 1 dollar, is pressed per game established peculiarly to the slot game machine 1; a maximum bet button 3m for betting a maximum unit betting amount; for example, 3 unit betting amount or 5 unit betting amount established peculiarly to the slot game machine 1 and simultaneously starting the rotation of the mechanical reels 6a, 6b, 6c; and a bet display unit 3a for displaying how many units have been bet.

In addition, further provided to the operational table 1t are a play button 3s for starting the rotation of the mechanical reels 6a, 6b, 6c; a change button 3c for calling a clerk to exchange money; and a cash out button 3o for dispensing accumulated cash of the balance upon subtracting the amount used in the game from the wager inserted into the coin slot 2a or bill slot 2b by the player p, and the acquired dividend of the prize won in the slot game.

Moreover, a ticket out opening 4o is provided to the lower wall face of the operational table it at the front face of the slot game machine 1, and there are cases where an exchange ticket of the payout amount is ejected from such ticket out opening 4o instead of cash.

A payout receiver 4u is provided at the lower part of the ticket out opening 4o by protruding anteriorly from the wall face, and the exchange ticket ejected from the ticket out opening 4o, or when the settlement of the game is made in cash, the paid out coins are retained in a hopper (not shown) when the game is finished.

Next, the structure of the control unit of the slot game machine 1 is described.

As shown in FIG. 5, the control means 20 for controlling the slot game machine 1 is structured by comprising a CPU (central processing unit) 20a as the center of such control; an EPROM (Erasable and Programmable ROM) 20b having written thereon a control program in advance; a RAM (Random Access Memory) 20c for storing work data; an image control means 20d for controlling image data and converting this into an analog signal and outputting the same; and a RAM 20e as a graphic memory, among others.

The series of movements of the slot game machine 1 is performed by the CPU 20a executing the control program stored in the EPROM 20b.

The foregoing control program performs, for example, the drive and stop position control of the respective stepping motors for rotatably driving each mechanical reel 6a, 6b, 6c; various processing such as the bet processing pursuant to the input operations of the player and calculation of the balance of the wager; control for printing and ejecting the exchange ticket; flashing operation control of various lamps; game sound output control, and so on.

Moreover, the EPROM 20b has the control data and table for performing the rotational drive stoppage control of the mechanical reels 6a, 6b, 6c.

The tables stored in the EPROM 20b are a winning design combination table, stoppage control table of the mechanical reels, and so forth.

The foregoing winning design combination table stores data prescribing the winning combination design for determining the realization of winning hands, and stores data on the prize to be provided to the player in accordance with the realization of various winning hands.

Here, the realization of the winning hands determined by the combination of designs displayed on the respective mechanical reels 6a, 6b, 6c in which the rotation has stopped is set by employing a random number arising in a prescribed probability among the random numbers generated with a random number generator.

The stoppage control table used in the stoppage control of the mechanical reel is recorded in association with the designs of the respective mechanical reels 6a, 6b, 6c and the arrangement thereof, and, when the relative positional relationship among one of the designs of the respective mechanical reels 6a, 6b, 6c is set forth, the mutual positional relationship of the other designs will be set forth naturally.

For example, when the number of designs of each mechanical reel 6a, 6b, 6c is 16, designs codes 1 to 16 are respectively provided to the designs 6an, . . . , 6bn, 6cn, of each mechanical reel 6a, 6b, 6c, and, with the design of the design code 1 as the reference, the relative positional relationships of the other designs are recognized, and stoppage control is performed for the respective reels 6a, 6b, 6c.

The foregoing RAM 20c generates a work area upon executing the control program and temporarily stores variable data or the like.

In other words, data relating to the inserted amount, balance, acquired prize and so on of the player p are stored therein.

By executing the control program stored in the EPROM 20b, the CPU 20a is able to comprehensively perform the overall control of the slot game machine 1; for instance, control of the respective stepping motors for rotatably driving each of the foregoing mechanical reels 6a, 6b, 6c; various processing according to the input operations of the player; and processing to be performed to the image control circuit 20d.

The control means 20 is connected to an external storage device gm such as a CD-ROM, and the external storage device gm stores image data and sound data for the game.

Moreover, the control means 20 is connected to a stepping motor M1, stepping motor M2 and stepping motor M3 for respectively driving the mechanical reels 6a, 6b, 6c; a reel lamp I (6al), reel lamp II (6bl) and reel lamp III (6cl) within the respective mechanical reels 6a, 6b, 6c; a position sensor I (22a), position sensor II (22b) and position sensor III (22c) for detecting the rotational position of the respective mechanical reels 6a, 6b, 6c, via the interface 21a including the motor drive circuit, sensor circuit, and so on.

Further, the control means 20 is also connected to a speaker sp for generating game effect sounds via the interface 21b, this interface 21b is a sound circuit for decoding the sound signal and outputting this from the speaker sp as an audio signal.

In addition, the control means 20 is also connected, via an interface 21c such as a chattering prevention circuit or the like, to a bill recognition device 24 for reading the bill inserted from the bill slot 2b; a coin acceptor 25 for checking whether the coin inserted from the coin slot 2a is genuine; a ticket printer 26 for printing the exchange ticket; a hopper 27 for paying coins at the end of the game in the case of cash settlement; a counter 28 which counts the amount inserted into or paid out from the slot game machine 1 for the game machine administrator; ornamental lamps 29 for providing game effect light; among others.

Further, the control means 20 is also connected to structural elements 3T of other buttons and the like via an interface 21e.

Moreover, the CPU 20a in the control means 20 is connected to the liquid crystal display panel 5 via the image control circuit 20d.

The CPU 20a reads the image data stored in the CD-ROM as the external storage device gm and performs actual drawing processing, and outputs the obtained image data to the image control circuit 20d via the RAM 20e, which is a graphic memory.

The image control circuit 20d performs digital/analog conversion and the like on the image data input from the CPU 20a, outputs this as an RGB signal to the liquid crystal display panel 5, and this is displayed as an image on the liquid crystal display panel 5.

Next, the game display within the protective glass 1g in the slot game machine 1 is explained.

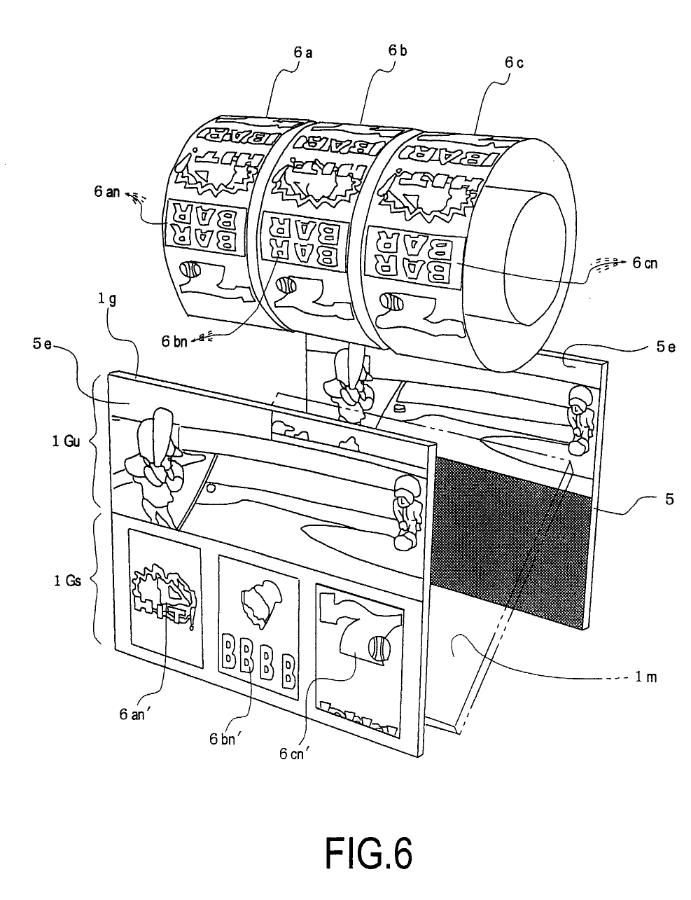

As the first display mode, as shown in FIG. 6, the image 5e is displayed at the upper half area of the liquid crystal display panel 5, and a dark color is displayed all across the lower half area.

Simultaneously, the illuminance of the reel lamp I (6al), reel lamp II (6bl) and reel lamp III (6cl) is increased in the respective mechanical reels 6a, 6b, 6c in order to illuminate and conspicuously display the designs 6an, . . . , 6bn, . . . , 6cn, . . . on the peripheral face of the mechanical reels 6a, 6b, 6c, and this is reflected on the half mirror lm in order to display the virtual images 6an′, 6bn′, 6cn′ on the game display area 1Gs, which corresponds to the dark colored lower half area of the liquid crystal display panel 5.

In this case, the player p visually recognizes the image 5e on the upper half area of the liquid crystal display panel 5 at the upper half area 1Gs of the game display and visually recognizes the virtual images 6an′, 6bn′, 6cn′ of the designs 6an, 6bn, 6cn of the respective mechanical reels 6a, 6b, 6c at the lower half area 1Gu of the game display through the protective glass 1g.

Here, the designs 6an, 6bn, 6cn of the respective mechanical reels 6a, 6b, 6c are illuminated brighter by the reel lamp I (6al), reel lamp II (6bl) and reel lamp III (6cl) the illuminance of which has been increased, reflected on the half mirror 1m, and, clearly projected as the virtual images 6an′, 6bn′, 6cn′, and at the same time the lower half area of the liquid crystal display panel 5 which is to be the background of the virtual images 6an′, 6bn′, 6cn′ is made of a dark color. As a result, the virtual images 6an′, 6bn′, 6cn′ of the designs 6an, 6bn, 6cn on the respective mechanical reels 6a, 6b, 6c are displayed clearly, and the player p will feel that he/she is viewing the designs 6an, 6bn, 6cn on the actual mechanical reels 6a, 6b, 6c.

According to the foregoing display, in addition to being able to enjoy the slot game by employing the virtual images 6an′, 6bn′, 6cn′ of the designs 6an, 6bn, 6cn of the mechanical reels 6a, 6b, 6c in the lower half area 1Gs of the game display, a widely diverse game display can be structured since a game display or image game and the like pursuant to an image 5e displayed on the liquid crystal display panel 5 can also be displayed in the upper half area 1Gu of the game display.

Meanwhile, as the second display mode, as shown in FIG. 7, the reel lamps 6al, 6bl, 6cl within the mechanical reels 6a, 6b, 6c are turned off in order to stop the illumination on the designs 6an, 6bn, 6cn for discontinuing the conspicuous display, and the virtual displays 6an′, 6bn′, 6cn′ of the designs 6an, 6bn, 6cn are eliminated from the lower half area 1Gs of the game display.

Simultaneously, when displaying the image 5el to the lower half area of the liquid crystal display panel 5, the player p will visually recognize the image 5e of the liquid crystal display panel 5 at the lower half area 1Gu of the display through the protective glass 1g, and will also visually recognize the image 5el of the liquid crystal display panel 5 in the lower half area 1Gs of the game display.

According to the foregoing display, the player p will visually recognize the image displayed on the liquid crystal display 5 across the entire area of both the upper half area 1Gu and lower half area 1Gs of the game display, and he/she may play an image game employing the entire area (1Gu, 1Gs) of the game display.

Moreover, in the embodiments described above, as illustrated in FIG. 4, description was made on an example where the image 5e of the liquid crystal display panel 5 is displayed on the upper half area 1Gu of the game display to be viewed by a player p and the designs 6an, 6bn, 6cn of the mechanical reels 6a, 6b, 6c are displayed in the lower half area 1Gs as the virtual images 6an′, 6bn′, 6cn′ after being reflected by the half mirror 1m. In addition to this game display arrangement, however, the designs 6an, 6bn, 6cn of the mechanical reels 6a, 6b, 6c may be displayed on the upper half area 1Gu as the virtual images 6an′, 6bn′, 6cn′ after being reflected by the half mirror 1m and the image 5e of the liquid crystal display panel 5 may be displayed on the lower half area 1Gs. Further, the game display area may be divided into an upper area, center area and lower area, such that the designs 6an, 6bn, 6cn of the mechanical reels 6a, 6b, 6c are displayed at the center area of the game display as the virtual images 6an′, 6bn′, 6cn′ after being reflected by the half mirror 1m, and the image 5e of the liquid crystal display panel 5 may be displayed on the upper area and lower area. The arrangement of the virtual images 6an′, 6bn′, 6cn′ of the designs 6an, 6bn, 6cn of the mechanical reels 6a, 6b, 6c and the image 5e of the liquid crystal display panel 5 may be suitably and arbitrarily selected.

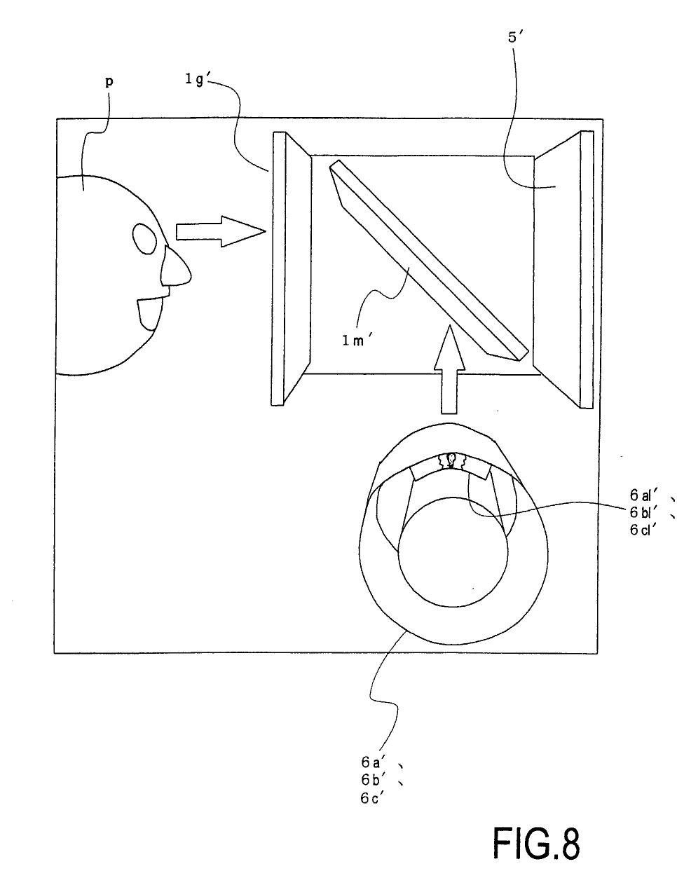

Further, in the foregoing embodiments, as shown in FIG. 3, although the mechanical reels 6a, 6b, 6c are disposed above the half mirror 1m, as shown in FIG. 8, the half mirror 1m′ may be disposed in a downward and inclined manner toward the liquid crystal display panel 5′ side and the mechanical reels 6a′, 6b′, 6c′ may be disposed below such half mirror 1m′.

In this case, however, in order to display the designs of the mechanical reels 6a′, 6b′, 6c′ as virtual images at a position on the game display similar to the foregoing embodiments, the position of the front and back directions of the mechanical reels in the slot game machine 1 has to be disposed at a position opposite the position of the front and back directions of the mechanical reels 6a, 6b, 6c of the foregoing embodiments.

For instance, as shown in FIG. 3, when the mechanical reels 6a, 6b, 6c are to be disposed at the front side of the slot game machine 1 in the foregoing embodiments, the mechanical reels 6a′, 6b′, 6c′ in the present embodiment, as shown in FIG. 8, are disposed at the backside of the slot game machine. Contrarily, if the mechanical reels 6a, 6b, 6c are to be disposed at the backside of the slot game machine 1 in the foregoing embodiments, the mechanical reels 6a′, 6b′, 6c′ in the present embodiment must be disposed at the front side of the slot game machine.

According to the foregoing structure, in the game display area visually recognized through the protective glass, since the image of the liquid crystal display is displayed and the designs of the mechanical reel peripheral face are displayed as virtual images by being reflected on the half mirror upon disposing the mechanical reels inside the top box positioned above the game display unit, the player will visually recognize the virtual images of the designs as though the designs of actual mechanical reels, and he/she may play a slot game having the same realism as actual mechanical reels.

Moreover, in the slot game machine, since the mechanical reels requiring the securement of volume are disposed above or below the game display unit and the planar shaped liquid crystal display panel is disposed facing the player; that is, in the depth direction, the depth measurement of the slot game machine can be reduced, the set-up are for the slot game machine will thereby decrease, and the occupancy area necessary for setting up the slot game machine is thereby narrowed and reduced.

For example, in a slot game machine, when disposing the mechanical reel behind the half mirror and disposing the liquid crystal display panel above or below the half mirror, the depth measurement of the slot game machine will become approximately 35 inches.

Whereas, according the present structure, by disposing the liquid crystal display panel at a position facing the player, disposing the mechanical reel on a line intersecting with the line connecting the liquid crystal display panel and the player, and disposing the half mirror inclined toward the liquid crystal display panel side or the player side, the depth measurement of the slot game machine will become approximately 20 inches, thereby significantly reducing the depth measurement. This measurement is approximately the same size as a conventional mechanical reel-type standard game machine even upon comprising at least a plurality of structural components such as the mechanical reels and liquid crystal display panel.

Further, since the illumination of the reel lamps is adjustable, by suitably adjusting the illuminance thereof, the designs on the peripheral face of the mechanical reels can be displayed in various clearness as the virtual images by being reflected on the half mirror, and the virtual images of the designs can be represented on the game display by adjusting the illuminance of the reel lamps.

Moreover, by employing a flat panel display such as a liquid crystal display panel or the like as the image display unit, the thickness measurement of the image display unit can be significantly reduced, thereby further reducing the depth measurement of the slot game machine.

Therefore, the occupancy area upon setting up the slot game machine can be narrowed and reduced, and, since numerous slot game machines can be set up on the same game room floor, the operating capacity of the game room floor will increase, thereby realizing a slot game machine yielding high profitability.

In addition, as described above, since a first display mode employing a virtual image of the design of the mechanical reel and an image displayed by the liquid crystal display panel, and a second display mode employing only the image displayed with the liquid crystal display panel are provided, a game structure of a diverse variety is realized.

Thus, realized is a slot game machine capable of successfully combining a game having the realism of a mechanical reel and a display having diverse and rich expressions, the set-up area thereof being narrow and small, and which yields high profitability.

Further, although a slot game machine was exemplified in the foregoing embodiments, it goes without saying that the game machine according to the present invention may be effectively employed in other game machines comprising other mechanical reels.

What is claimed is:

1. A game machine wherein an image display unit is disposed at a position facing a player side, a mechanical reel is disposed on a line intersecting a line connecting the image display unit and the player side, and an illuminance-adjustable illumination unit is provided for illuminating the mechanical reel; and
wherein, by providing a half mirror, that is inclined toward the image display unit side or the player side, in front of the image display unit and within a plane including an area where the lines intersect, an image from the image display unit that has transmitted through the half mirror and a virtual image of a design drawn on a peripheral face of the mechanical reel that is reflected by the half mirror are displayed on a same face to a player.

2. A game machine according to claim 1, wherein the image display unit comprises a flat panel display.

3. A game machine according to claim 2, wherein the flat panel display is a display panel selected from among a liquid crystal display panel, a plasma display panel, an electro-luminescent display panel, and an organic electro-luminescent display panel.
